(19) United States
(12) Patent Application Publication
(10) Pub. No.: US 2025/0276607 A1
(43) Pub. Date: Sep. 4, 2025

(54) ELECTRICITY-DRIVEN VEHICLE

(71) Applicants: TOYOTA JIDOSHA KABUSHIKI KAISHA, Aichi-ken (JP); ISUZU MOTORS LIMITED, Kanagawa (JP)

(72) Inventors: Masayoshi WATANABE, Nagoya-shi (JP); Kan SAITO, Ikeda-shi (JP); Toshiya TSUJITA, Ikeda-shi (JP); Naohiro NAKAMURA, Ikeda-shi (JP); Yasuo KAWAMOTO, Ikeda-shi (JP); Hideki OGAMI, Ikeda-shi (JP)

(21) Appl. No.: 19/063,296

(22) Filed: Feb. 26, 2025

(30) Foreign Application Priority Data
Feb. 29, 2024 (JP) 2024-029868

(51) Int. Cl. B60L 53/80

(52) U.S. Cl. CPC B60L 53/80

(57) ABSTRACT

An electricity-driven vehicle includes: a rear side door opening that is opened and closed by a rear side door, a battery loading portion that is placed at an upper side in relation to a lower end of the rear side door opening, and at an upper side in relation to a floor panel; and one or more batteries of a replaceable type, that are inserted into and removed from the battery loading portion from a side of the vehicle. The battery loading portion is fitted within a width of the rear side door opening in a front-and-rear direction.

### CROSS REFERENCE TO RELATED APPLICATION

This application claims priority to Japanese Patent Application No. 2024-029868 filed on Feb. 29, 2024, which is incorporated herein by reference in its entirety including the specification, claims, drawings, and abstract.

### TECHNICAL FIELD

The present disclosure relates to an electricity-driven vehicle, equipped with a replaceable battery.

### BACKGROUND

In the related art, an electricity-driven vehicle is widely known, in which a motor which is a motive power source, and a battery which supplies electric power to the motor are provided on a vehicle. The battery equipped in the electricity-driven vehicle is a secondary battery which can be charged and discharged, and is charged by an external power source as necessary.

A configuration is being proposed which employs a replaceable battery, which can be attached to and detached from the electricity-driven vehicle, in order to effectively utilize the electricity-driven vehicle even during charging of the battery. In a structure with a replaceable battery, when a state of charge of the battery equipped on the electricity-driven vehicle becomes low, the battery is removed from the electricity-driven vehicle, and is replaced with another battery which is charged in advance. The battery which is removed from the electricity-driven vehicle is then charged outside the electricity-driven vehicle. Because the electricity-driven vehicle can travel even during the charging of the removed battery, the electricity-driven vehicle can be more effectively utilized.

A replaceable battery should be placed at a location where the battery can be easily attached and detached. JP 2012-151916 A discloses a technique in which the replaceable battery is placed at a lower side of a floor panel of a vehicle. According to this technique, the user can easily insert and remove the replaceable battery from a side of the vehicle.

However, in the technique of JP 2012-151916 A, in order to secure a mounting space of the replaceable battery, a placement height of the floor panel must be significantly increased as compared with the existing vehicles. Because of this, for the technique of JP 2012-151916 A, a vehicle body structure of the existing vehicle cannot be utilized.

An advantage of the present disclosure lies in provision of an electricity-driven vehicle having only a small extent of design change from the vehicle body structure of the existing vehicles, while being equipped with a replaceable battery.

### SUMMARY

According to one aspect of the present disclosure, there is provided an electricity-driven vehicle comprising: a rear side door opening that is opened and closed by a rear side door; a battery loading portion that is placed at an upper side in relation to a lower end of the rear side door opening, and at an upper side than a floor panel; and one or more batteries of a replaceable type, that are inserted into and removed from the battery loading portion from a side of the vehicle, wherein the battery loading portion is fitted within a width of the rear side door opening in a front-and-rear direction.

With the above-described structure, a user can easily access the battery loading portion from the rear side door opening, and easily replace the battery. In addition, because the battery is placed at the upper side of the floor panel, the placement height of the floor panel does not need to be significantly changed from that in the existing vehicle, thus resulting in a small extent of design change of the vehicle body structure from the existing vehicles.

In this case, the electricity-driven vehicle may further comprise a deck board, the floor panel may have a depressed portion of a groove shape, which extends in a vehicle width direction at a position at a rear side of a front seat, the deck board may be placed at an upper side of the floor panel so as to cover and hide the depressed portion, and may form a flat floor surface extending from a rear side of the front seat to a rear end of the vehicle, and the battery loading portion may be placed within a space surrounded by the deck board and the depressed portion.

With the above-described structure, the space at the rear side of the front seat can be effectively utilized as a baggage compartment.

The rear side door may be a sliding door, the floor panel may be welded to a vehicle body, and the deck board may be removable from the electricity-driven vehicle without destroying a component of the electricity-driven vehicle.

When the rear side door is a sliding door, interference between the battery to be inserted into and removed from the battery loading portion and the rear side door can be effectively prevented. With this configuration, workability of the replacement of the battery can be improved. Further, with the above-described structure, because the deck board can be easily removed, maintenance of the battery loading portion positioned at the lower side of the deck board can be easily performed.

The battery loading portion may include a battery casing of a box shape, which houses the one or more batteries of the replaceable type, the battery casing may include: a loading port provided at an end of the battery casing in a vehicle width direction; and a downward-opening casing lid which covers the loading port and which swings about an axis near the loading port, and a distance from the loading port to an end of the floor panel in the vehicle width direction may be approximately equal to a dimension of the loading port in an up-and-down direction, or may be larger than the dimension of the loading port in the up-and-down direction.

In a configuration in which a downward-opening lid is employed as the casing lid, when the casing lid is opened, the casing lid does not obstruct a field of view of the user viewing a periphery of the loading port. As a result, the workability of the replacement of the battery is improved. In addition, with the above-described structure, when the casing lid is opened, the casing lid does not extend to an outer side of the vehicle.

The electricity-driven vehicle may further comprise a pair of side members that are placed with a spacing in a vehicle width direction, the battery loading portion may be fitted within a width between the pair of side members, and a center of the battery loading portion in the vehicle width direction may be approximately coincident with a center of the electricity-driven vehicle in the vehicle width direction.

With the above-described structure, when the electricity-driven vehicle collides at the side, the side member receives the impact before the battery loading portion. Because of this, the damages to the battery at the time of the side collision can be effectively prevented. In addition, by placing the battery loading portion at the center of the vehicle, the placement of the battery loading portion can be easily inverted in regard to the left and right sides. By inverting the placement of the battery loading portion in the left and right sides, the battery can be inserted and removed in a direction according to the user's desires.

According to an aspect of the present disclosure, the extent of design change from the vehicle body structure of the existing vehicle may be reduced while a battery of the replaceable type is equipped.

### BRIEF DESCRIPTION OF DRAWINGS

Embodiment(s) of the present disclosure will be described based on the following figures, wherein:

FIG. 1 is a perspective diagram showing a region near a rear side door of an electricity-driven vehicle, viewed from outside the vehicle;

FIG. 2 is a schematic plan view of the electricity-driven vehicle;

FIG. 3 is a cross-sectional diagram along an A-A line of FIG. 2; and

FIG. 4 is a cross-sectional diagram along a B-B line of FIG. 2.

### DESCRIPTION OF EMBODIMENTS

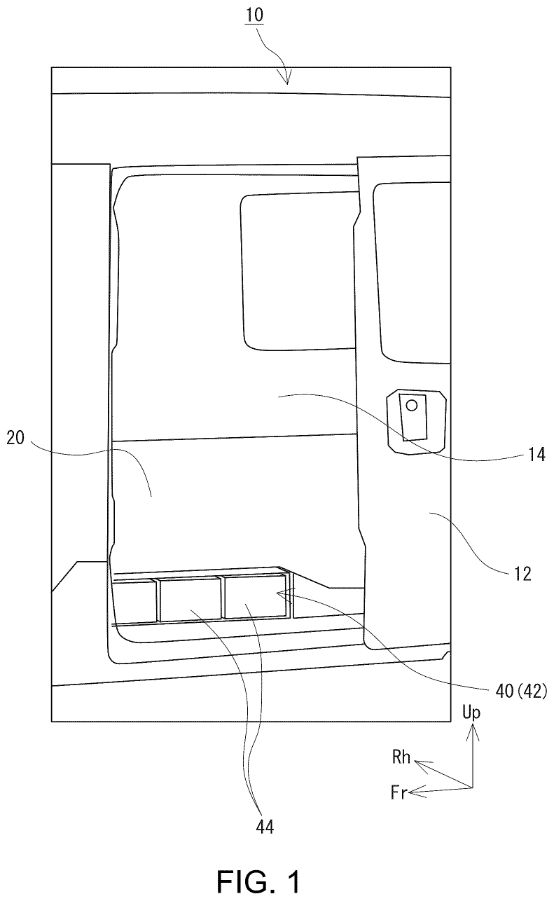

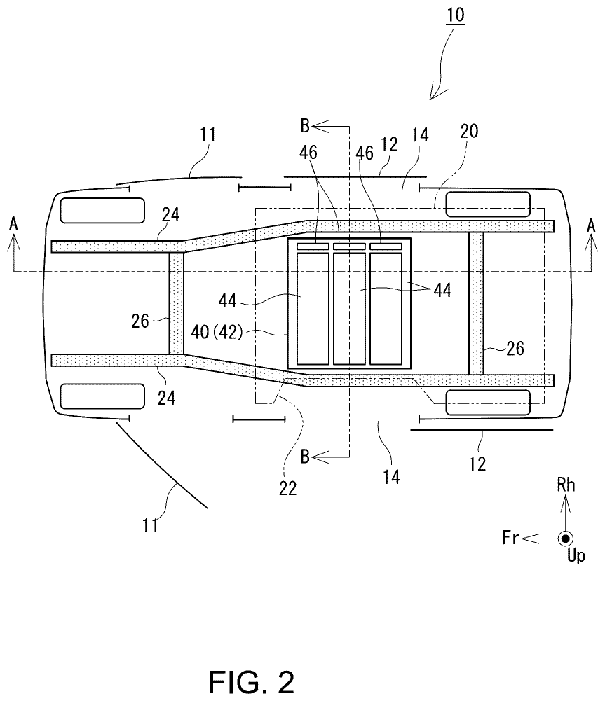

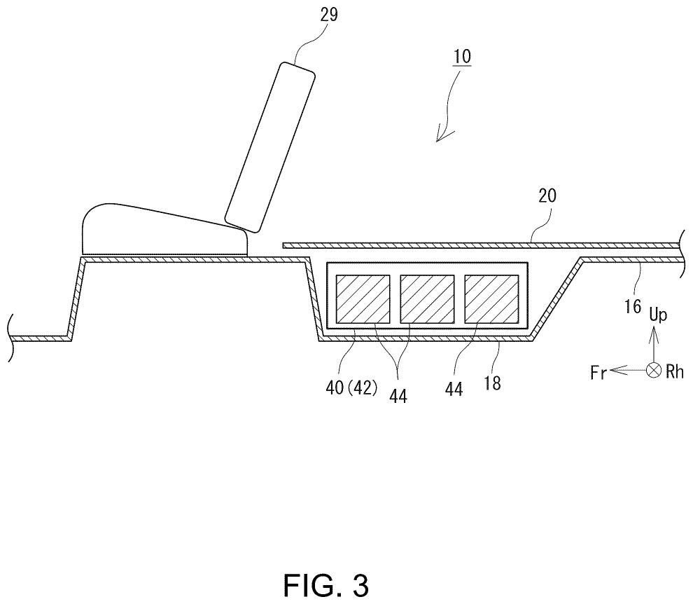

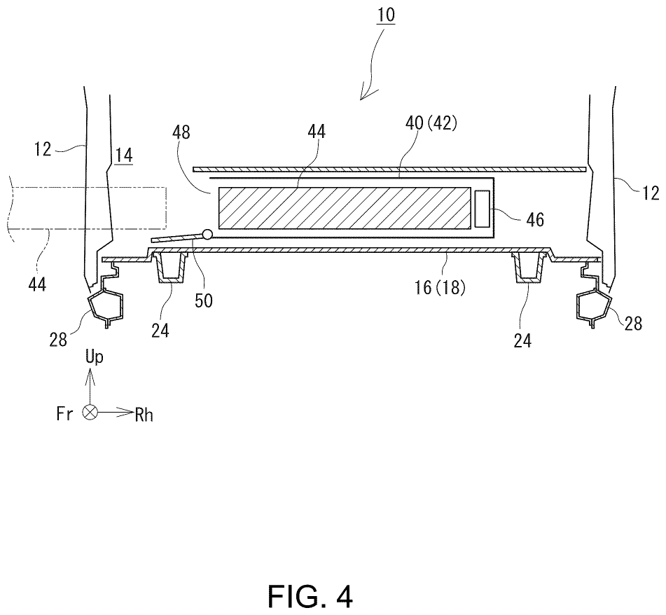

A structure of an electricity-driven vehicle 10 according to an embodiment of the present disclosure will now be described with reference to the drawings. FIG. 1 is a perspective diagram showing a region near a rear side door 12 of the electricity-driven vehicle 10, viewed from outside the vehicle. FIG. 2 is a schematic plan view of the electricity-driven vehicle 10. FIG. 3 is a cross-sectional diagram along an A-A line of FIG. 2, and FIG. 4 is a cross-sectional diagram along a B-B line of FIG. 2. In the drawings, “Fr”, “Up”, and “Rh” respectively refer to a front side, an upper side, and a right side of the electricity-driven vehicle 10.

The electricity-driven vehicle 10 comprises a traveling motor (not shown), and a battery 44 which supplies electric power to the traveling motor. The electricity-driven vehicle 10 exemplified below is a commercial vehicle for transporting baggage. A rear seat of the electricity-driven vehicle 10 is removed, in order to improve a loading efficiency of the baggage. Therefore, an entirety of a rear side of a front seat 29 (not shown in FIG. 1; refer to FIG. 3) can be used as a baggage compartment. On a side of the electricity-driven vehicle 10, a front side door 11 and a rear side door 12 are placed, aligned in a front-and-rear direction. As shown in FIG. 2, the front side door 11 is a hinge door which swings about an axis extending in a vertical direction, and the rear side door 12 is a sliding door which slides in a vehicle front-and-rear direction. The rear side door 12 opens and closes a rear side door opening 14.

The battery 44 is a replaceable battery which can be easily replaced in the electricity-driven vehicle 10. The battery 44 is formed by housing a battery body formed from a plurality of unit cells in a housing. The housing of the battery 44 has, for example, a parallelepiped shape elongated in a vehicle width direction. A battery-side connector is provided at an end of the battery 44. When the battery-side connector is connected to a vehicle-side connector 46 to be described below, an electric power system equipped on the vehicle and the battery 44 are electrically connected with each other. The battery body is a secondary battery (for example, a lithium ion battery or the like) which can be charged and discharged. Therefore, the battery 44 which is removed from the electricity-driven vehicle 10 can be charged externally to the vehicle.

By setting the battery 44 as a replaceable battery in this manner, the usage efficiency of the electricity-driven vehicle 10 can be improved, and a demand peak of commercial electric power can be reduced. That is, when the battery 44 is of the replaceable type, after the battery 44 is removed from the electricity-driven vehicle 10, another battery 44 which is already charged can be mounted on the electricity-driven vehicle 10. Further, with such a configuration, because the electricity-driven vehicle 10 can travel even during a period in which a part of the battery 44 is charged, the usage efficiency of the electricity-driven vehicle 10 is improved. In addition, when the battery 44 is of the replaceable type, time of performing the charging operation can be freely selected, regardless of a usage situation of the electricity-driven vehicle 10. Because of this, the battery 44 can be charged during a time period of low demand of the commercial electric power (for example, at late night), and the demand peak of the commercial electric power can be reduced.

Such a battery 44 is mounted at a location where a user can easily replace the battery and where loading of the baggage is not obstructed. In the case of the electricity-driven vehicle 10 of the present disclosure, a battery loading portion 40 at which the battery 44 is loaded is provided at an adjacent position of the rear side door opening 14. The battery loading portion 40 will now be described in detail.

First, prior to the description of the battery loading portion 40, a basic vehicle body structure of the electricity-driven vehicle 10 will be described. The electricity-driven vehicle 10 has a vehicle body structure approximately identical to that of existing vehicles. By using the vehicle body structure of the existing vehicles as is, components and manufacturing processes can be made common with the existing vehicles, resulting in reduction of development and manufacturing costs of the electricity-driven vehicle 10. As shown in FIGS. 2 and 4, the electricity-driven vehicle 10 comprises a pair of side members 24 placed with a spacing in the vehicle width direction, and a plurality of cross members 26 connecting the pair of side members 24. Each of the side members 24 and the cross members 26 is a frame of the electricity-driven vehicle 10.

As shown in FIG. 4, at an upper side of the side member 24, a floor panel 16 is provided. The floor panel 16 is a steel plate panel forming a floor surface of a vehicle cabin. The floor panel 16 is welded to the frame (side member 24 or the like) of the electricity-driven vehicle 10. As shown in FIG. 3, at an immediately rear side of the front seat 29, a depressed portion 18 is present. The depressed portion 18 is a portion which extends in the vehicle width direction and which is depressed in a groove shape. In the case of the existing vehicles, a rear seat is placed at an immediately rear side of the depressed portion 18. As described above, in the case of the electricity-driven vehicle 10 of the present embodiment, the rear seat is removed.

At a laterally adjacent position of the depressed portion 18, the rear side door opening 14 is placed. As shown in FIG. 4, a lower end of the rear side door opening 14 is defined by a rocker 28. The rocker 28 is one type of a frame extending in the vehicle front-and-rear direction. Here, as shown in FIG. 4, a height of a bottom surface of the depressed portion 18 is close to a height of the lower end of the rear side door opening 14. Because of this, when the rear side door 12 is opened, the upper side of the depressed portion 18 (that is, the floor panel 16) can be easily accessed, but the lower side of the depressed portion 18 cannot be easily accessed. Such a shape and a placement of the floor panel 16 are similar to those of the existing vehicle. That is, in the existing vehicle also, the height of the bottom surface of the depressed portion 18 of the floor panel 16 is close to the height of the lower end of the rear side door opening 14.

In the present embodiment, as shown in FIG. 4, the battery loading portion 40 is provided at an upper side in relation to the depressed portion 18 (that is, the floor panel 16), and at an upper side than the lower end of the rear side door opening 14. In addition, as shown in FIG. 2, the battery loading portion 40 is completely fitted within a width of the rear side door opening 14 in the front-and-rear direction. By employing such a configuration, the user can easily access the battery loading portion 40 through the rear side door opening 14. Moreover, by placing the battery loading portion 40 at the upper side of the floor panel 16 it becomes unnecessary to significantly change the position of the floor panel 16 from that in the existing vehicle, and the vehicle body structure of the existing vehicle can thus be utilized without a change.

The battery loading portion 40 is a part at which the battery 44 is loaded. The battery loading portion 40 has, for example, a battery casing 42. As shown in FIG. 4, the battery casing 42 is a container which houses one or more batteries 44 (in the illustrated example configuration, three batteries 44), and is a box approximately having a parallelepiped shape with one end in the vehicle width direction opened. The opening of the battery casing 44 at one end in the vehicle width direction serves as a loading port 48 through which the battery 44 is inserted and removed. When the battery 44 is to be replaced, the user accesses the battery casing 42 from a side of the electricity-driven vehicle 10 (in the illustrated example configuration, the left side), and inserts or removes the battery 44 via the loading port 48. As described above, in the present embodiment, the rear side door 12 is the sliding door. By employing the sliding door, interference between the battery 44 to be inserted or removed and the rear side door 12 can be effectively prevented, and workability when the battery 44 is replaced can be improved.

The loading port 48 is opened and closed by a casing lid 50. For example, the casing lid 50 is a downward-opening lid which swings with the center near a lower end of the loading port 48. By employing the downward-opening lid as the casing lid 50, a configuration is achieved in which, when the casing lid 50 is opened, the casing lid 50 does not interpose between eyes of the user (which are normally positioned above the loading port 48) and the loading port 48. With this configuration, the user can more easily see the periphery of the loading port 48, and, as a consequence, the workability when the battery 44 is replaced can be improved. In addition, in the case of the illustrated example configuration, a dimension of the casing lid 50 in the up-and-down direction is significantly smaller than the dimension of the casing lid 50 in the front-and-rear direction. Thus, by employing a configuration where the casing lid 50 opens downward, as compared with a case where the casing lid 50 opens laterally, an amount of protrusion when the casing lid 50 is opened can be set small. However, the structure of the casing lid 50 is not limited to the illustrated example configuration, and may be suitably changed. For example, the casing lid 50 may be changed to a laterally opening type, a double door type, or a sliding type.

In the battery casing 42, the connector 46 to be electrically connected to the battery 44 loaded in the battery casing 42 is provided. The battery 44 is electrically connected to an electric power system which is equipped in the vehicle, via the connector 46.

As shown in FIGS. 2 and 4, the battery loading portion 40 (that is, the battery casing 42) is fitted within a width between two side members 24 in the plan view. With such a configuration, when the electricity-driven vehicle 10 collides at the side, the side member 24 receives the impact before the battery loading portion 40. Because of this, damage to the battery 44 housed in the battery loading portion 40 is effectively prevented.

In addition, as shown in FIG. 4, a distance from the loading port 48 to an end of the floor panel 16 in the vehicle width direction is equal to a dimension of the loading port 48 in an up-and-down direction, or is larger than the dimension of the loading port 48 in the up-and-down direction. By employing such a structure, when the downward-opening casing lid 50 is opened, the casing lid 50 does not extend to the outside of the vehicle.

Moreover, a center of the battery loading portion 40 in the vehicle width direction is approximately coincident with a center of the electricity-driven vehicle 10 in the vehicle width direction. With such a configuration, the placement of the battery loading portion 40 can be easily inverted in the left and right sides, and a direction of replacement of the battery 44 can be easily changed. Specifically, in the drawings, an example configuration is illustrated in which the battery 44 is replaced from the left side of the electricity-driven vehicle 10. However, in some cases, depending on the user's desires, it may be desired to replace the battery 44 from the right side of the electricity-driven vehicle 10. In order to fulfill such desires of the user, the placement of the battery loading portion 40 may in some cases be inverted in the left and right sides, before the user purchases the electricity-driven vehicle 10. In such cases, if the center of the battery loading portion 40 is coincided with the center of the electricity-driven vehicle 10, an extent of the structural change of the electricity-driven vehicle 10 due to the left-right inversion can be reduced.

As shown in FIG. 3, a height of the battery casing 42 is shorter than a depth of the depressed portion 18. The electricity-driven vehicle 10 further comprises a deck board 20 placed at an upper side of the floor panel 16 so as to cover and hide the depressed portion 18. In other words, the battery loading portion 40 is placed in a space surrounded by the deck board 20 and the depressed portion 18. As shown in FIGS. 2 and 3, the deck board 20 forms a flat floor surface, extending from a rear side of the front seat 29 to a rear end of the vehicle. By providing such a deck board 20, the entirety of the space behind the front seat 29 can be used as a baggage compartment, and thus, a transport efficiency of the baggage by the electricity-driven vehicle 10 can be improved.

The deck board 20 is not welded to any of the members of the electricity-driven vehicle 10, and can be removed from the electricity-driven vehicle 10 without destroying a component of the electricity-driven vehicle 10. By removing the deck board 20 from the electricity-driven vehicle 10 as necessary, maintenance or the like of the battery loading portion 40 can be easily performed. As shown in FIG. 2, a cutout 22 may be formed at a portion of the deck board 20 near the loading port 48. By forming the cutout 22, visibility of the periphery of the loading port 48 by the user can be further improved.

As is clear from the description above, according to the structure of the present disclosure, the battery 44 is placed adjacent the rear side door opening 14. As a result, the user can easily access the battery loading portion 40 via the rear side door opening 14, and the workability of the replacement of the battery 44 can thus be improved. In addition, as is clear from the description above, according to the structure of the present disclosure, the extent of the design change from that of the existing vehicle is small. As a result, the cost for development and manufacturing of the electricity-driven vehicle 10 can be reduced.

The structures described above are merely exemplary, and, so long as the electricity-driven vehicle has the structure described in claim 1, the other structures may be suitably changed. For example, in the above description, the rear side door 12 is described as a sliding door, but alternatively, the rear side door 12 may be a hinge door, similar to the front side door 11. Further, the structure of the battery loading portion 40 may also be suitably changed. For example, the shape and the size of the battery loading portion 40, and presence or absence of the casing lid 50 may be suitably changed.

### REFERENCE SIGNS LIST

10 electricity-driven vehicle, 11 front side door, 12 rear side door, 14 rear side door opening, 16 floor panel, 18 depressed portion, 20 deck board, 22 cutout, 24 side member, 26 cross member, 28 rocker, 29 front seat, 40 battery loading portion, 42 battery casing, 44 battery, 46 connector, 48 loading port, 50 casing lid

1. An electricity-driven vehicle comprising:
a rear side door opening that is opened and closed by a rear side door;
a battery loading portion that is placed at an upper side in relation to a lower end of the rear side door opening, and at an upper side in relation to a floor panel; and
one or more batteries of a replaceable type, that are inserted into and removed from the battery loading portion from a side of the vehicle, wherein
the battery loading portion is fitted within a width of the rear side door opening in a front-and-rear direction.

2. The electricity-driven vehicle according to claim 1, further comprising:
a deck board, wherein
the floor panel has a depressed portion of a groove shape, which extends in a vehicle width direction at a position at a rear side of a front seat,
the deck board is placed at an upper side of the floor panel so as to cover and hide the depressed portion, and forms a flat floor surface extending from a rear side of the front seat to a rear end of the vehicle, and
the battery loading portion is placed within a space surrounded by the deck board and the depressed portion.

3. The electricity-driven vehicle according to claim 2, wherein
the rear side door is a sliding door,
the floor panel is welded to a vehicle body, and
the deck board is removable from the electricity-driven vehicle without destroying a component of the electricity-driven vehicle.

4. The electricity-driven vehicle according to claim 1, wherein
the battery loading portion includes a battery casing of a box shape, which houses the one or more batteries of the replaceable type,
the battery casing includes:
a loading port provided at an end of the battery casing in a vehicle width direction; and
a downward-opening casing lid which covers the loading port and which swings about an axis near the loading port, and
a distance from the loading port to an end of the floor panel in the vehicle width direction is approximately equal to a dimension of the loading port in an up-and-down direction, or is larger than the dimension of the loading port in the up-and-down direction.

5. The electricity-driven vehicle according to claim 1, further comprising:
a pair of side members that are placed with a spacing in a vehicle width direction, wherein
the battery loading portion is fitted within a width between the pair of side members, and
a center of the battery loading portion in the vehicle width direction is approximately coincident with a center of the electricity-driven vehicle in the vehicle width direction.
